(19) United States
(12) Patent Application Publication
(10) Pub. No.: US 2002/0021903 A1
(43) Pub. Date: Feb. 21, 2002

(54) Electronic camera and remote-control operation system for external apparatus

(76) Inventors: Daisuke Ito, Asaka-shi (JP); Yoshio Nakane, Asaka-shi (JP); Kimiaki Nakada, Asaka-shi (JP)

Correspondence Address: BIRCH STEWART KOLASCH & BIRCH, PO BOX 747, FALLS CHURCH, VA, 22040-0747, US

(21) Appl. No.: 09/933,197

(22) Filed: Aug. 21, 2001

(30) Foreign Application Priority Data
Aug. 21, 2000 (JP) 2000-249866

(51) Int. Cl. G03B 17/48

(52) U.S. Cl. 396/429

(57) ABSTRACT

A digital camera is provided with a wireless communication part having an image transmitting function, and an external apparatus (e.g. a personal computer) is also provided with a wireless communication part of the same type. When the camera comes close to the external apparatus which is associated with the camera, the external apparatus enables the camera to operate via a wireless communication. The camera transfers a newly taken image to the external apparatus via the wireless communication, and the contents of the transferred data is at that point encoded based on identification data of a correspondence to be communicated with. The received image can be viewed at the side of the external apparatus, and at the same time forwarding a page of viewed images, enlargement of display, deletion of an image, and so forth, can be remotely controlled by an operating part of a body of the camera. Moreover, the external apparatus classifies the received image based on accessory data such as a date and a taking condition, and presents the received image to a user by a virtual folder display.

### BACKGROUND OF THE INVENTION

1. Field of the Invention

The present invention relates to an electronic camera with a function for converting an optical image into electric signals by a photoelectric-transfer imaging device, and a remote-control operation system for controlling an external apparatus with the electronic camera.

2. Description of the Related Art

Japanese Patent Application Laid-open No. 5-333260 discloses a remote control system for remotely controlling an electronic camera by infrared rays. Light emitting and receiving devices for active autofocusing of the camera are used as remote-control transmitter and receiver, respectively. Hence, the camera can be remotely controlled without a transmitter for only the remote-control. Japanese Patent Application Laid-open Nos.6-265960 and 6-265961 also disclose similar technique.

In the conventional technique, however, the camera is merely controlled by wireless. A digital camera transmits image data to an external apparatus such as a personal computer via a serial cable, in a wire communication method such as the USB, or in an infrared communication method such as the IrTranP. Since the communication is restricted due to the length of the cable or the directivity and output of the infrared rays, practical remote control is difficult.

### SUMMARY OF THE INVENTION

The present invention has been developed in view of the above-described circumstances, and has as its object the provision of an electronic camera which can be used as a remote-control transmitter for an external apparatus, and a remote-control operation system for controlling the external apparatus with the electronic camera.

In order to achieve the above-described objects, the present invention is directed to an electronic camera, comprising: a body; a control part provided to the body; a wireless communication device which transmits image data, wherein the wireless communication device transmits operation information corresponding with operation of the control part to an external apparatus to remotely control the external apparatus.

According to the present invention, the electronic camera has the wireless communication device that outputs operation signals to the external apparatus. The electronic camera serves as an image source which supplies the images to the external apparatus, and at the same time serves as a remote-control transmitter for the external apparatus. Therefore, an operator can remotely control the external apparatus with the electronic camera by hand without directly operating the external apparatus.

The control part may be used only for the remote control, and a camera control part may be used as the control part. Since the external apparatus determines its operation corresponding to the operation information, one electronic camera can be used for plural external apparatus. In addition, a new external apparatus can be added without any change of the camera.

Moreover, since the wireless communication device uses a radio-wave communication method such as Bluetooth, the restriction of the communication due to the directivity is smaller than that of the infrared communication.

The present invention is also directed to an electronic camera, comprising: a body; a taking lens; an imaging device which converts a light which has entered the electronic camera through the taking lens into electric signals; a recording device which records an image captured by the imaging device in a storage medium; a wireless communication device which transmits image data; a control part provided to the body, operational directions over an external device being entered through the control part; and an operation information outputting device which transmits, through the wireless communication device, operation information corresponding with operation of the control part to the external apparatus to remotely control the external apparatus.

An A/D converting device that converts the electric signals outputted from the imaging device into digital signals and a signal processing device that processes the digital signals may be added to the electronic camera. Further, a displaying device that displays the image may be added to the electronic camera.

The electronic camera may further comprise a storing device that stores identification information for specifying the external apparatus; a specifying device that specifies the external apparatus from the identification information stored in the storing device; and an encoding device that encodes the image data and the operation information according to the identification information.

The present invention is also directed to a remote-control operation system for an external apparatus, the system comprising an electronic camera and the external apparatus, wherein: an electronic camera comprises: a body; a taking lens; an imaging device which converts a light which has entered the electronic camera through the taking lens into electric signals; a recording device which records an image captured by the imaging device in a storage medium; a first wireless communication device which transmits image data; a control part provided to the body, operational directions over the external device being entered through the control part; and an operation information outputting device which transmits operation information corresponding with operation of the control part to the external apparatus to remotely control the external apparatus, and the external device comprises: a second wireless communication device which communicates with the first wireless communication device; and a displaying device which classifies images received from the electronic camera into image groups according to accessory information attached to the images and displays virtual folders, each of the virtual folders comprising each of the image groups, wherein the external apparatus operates according to the operation information received from the electronic camera.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a front view of a digital camera of an embodiment for the present invention;

FIG. 2 is a plan view of the digital camera in FIG. 1;

FIG. 3 is a rear view of the digital camera in FIG. 1;

FIG. 4 is a block view showing an inner structure of the digital camera of the present embodiment;

FIG. 5 is a schematic view of a system with a digital camera and a personal computer;

FIG. 6 is a view showing a communication sequence of the system in FIG. 5;

FIG. 7 is a view showing a state where an image transferred from the digital camera is displayed on a display screen;

FIG. 8 is a flowchart for a process of the digital camera of the present embodiment; and

FIG. 9 is a flowchart for a process of the personal computer which serves as an external apparatus.

### DETAILED DESCRIPTION OF THE PREFERRED EMBODIMENTS

Hereunder a preferred embodiment for an electronic camera and a remote-controlled operating system of an external apparatus therefor will be described in detail in accordance with the accompanied drawings.

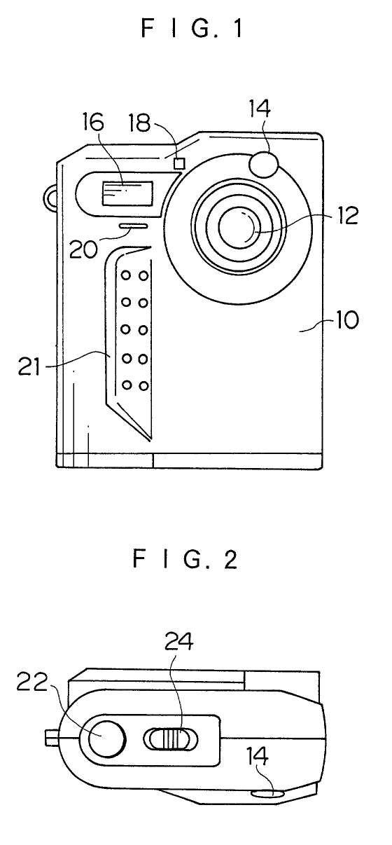

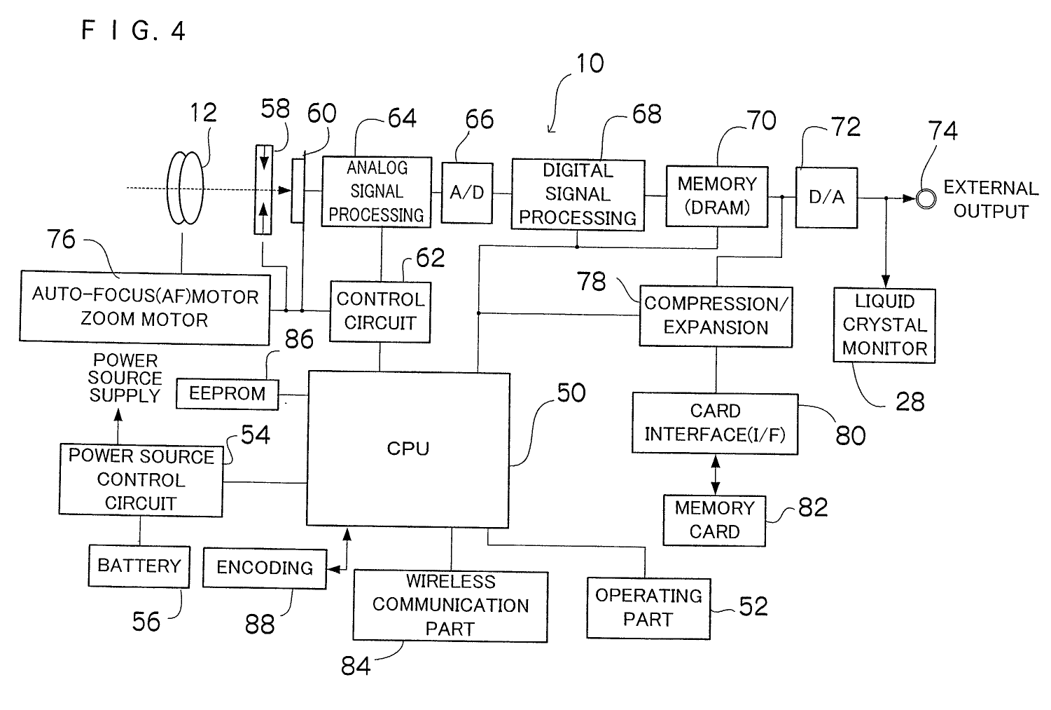

FIG. 1 is a front view of a digital camera of the present embodiment. As seen from FIG. 1, a digital camera (electronic camera) 10 is provided with a taking lens 12, a finder aperture 14, a strobe 16, a strobe emission adjusting sensor 18, a self-timer LED 20, and a CCD image sensor (not shown in FIG. 1 but recited with a reference number 60 in FIG. 4) as an imaging device, are arranged. A reference number 21 is a grip. Although not shown in the drawings, a card slot of a memory card (recited as a reference number 82 in FIG. 4), a digital input/output terminal, a video output terminal, and a DC power source terminal, are provided to the grip 21 and to a side face of the digital camera 10 which is opposite to the grip 21. Moreover, the digital camera 10 has a function for exchanging data via a wireless communication with a faint electric wave (e.g. a communication interface for Bluetooth).

As seen from FIG. 2, a release button 22 and a power source switch 24 are provided on the top face of the digital camera 10. The release button 22 has two steps to be pressed, in which an automatic focusing (AF) is performed in a state where the release button 22 is lightly pressed and held, “half-press”, and an auto-exposure control (AE) is activated to lock AF and AE and a taking is executed in a state where the release button 22 is now fully pressed, called “full-press” from the half-press state.

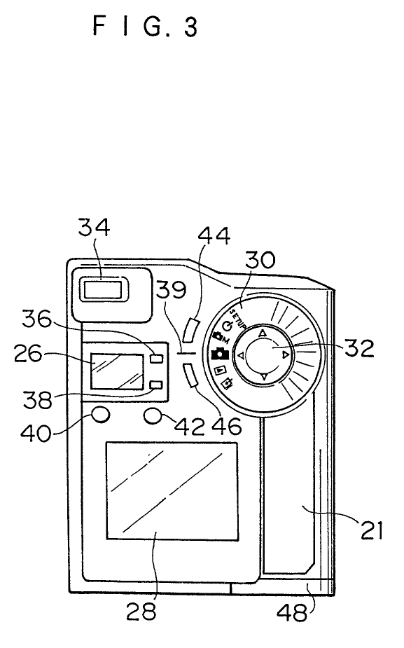

FIG. 3 is a rear view of the digital camera 10. The rear face of the digital camera 10 is provided with a liquid crystal panel 26 for displaying characters, a liquid crystal monitor 28, a mode dial 30, a four-direction button 32, a finder 34, and so forth. The liquid crystal panel 26 for displaying characters is a display part for displaying data related to a state, a taking mode, and so forth of the digital camera 10 by using characters and simple figures. Examples of such data to be displayed are: a battery checking, number of frames and a frame umber which can be taken, presence of strobe emission, macro mode, recorded image quality (quality), and number of image pixels.

At a side of the liquid crystal panel 26 for displaying characters, a strobe button 36 for switching a mode of a strobe taking and a macro button 28 for setting at a close-distance taking mode (macro mode) are disposed.

The liquid crystal monitor 28 is a display means for displaying a preview image of a taken image and a reproduced image which is read out from a memory card while it can be used also as an electronic finder for confirming an angle of view at a time of taking. Moreover, selecting menu and setting the respective items in the menu by using a four-direction button 32 are performed by referring to the display screen of the liquid crystal monitor 28.

The mode dial 30 is a means for changing a function of the digital camera 10. The mode dial 30 is rotated and a mark of the respective modes marked on a dial is matched with an index point 39, whereby a mode can be selected from a set-up mode, a self-timer taking mode, a manual taking mode, a normal taking mode, a reproducing mode, a PC mode, and so forth.

The four-direction button 32 can input instructions of the four directions (up, down, right, and left) by pressing one of the four ends which is desired. The four-direction button 32 is used as an operation button for selecting the respective setting items and instructing changing of the set contents on the menu screen, and it is at the same time used also as a means for instructing magnification adjustment of the electronic zoom, moving a center of the zoom, and forwarding and reversing the reproduced frames.

A reference numbers 40 and 42 are a shift button and a display button, respectively. The shift button 40 is a push switch for expanding a function of a key switch of the four-direction button 32 and other keys, whereas the display button 42 is an operating means for operating ON/OFF of the liquid crystal monitor 28 and switching display/non-display of a frame number and the like being reproduced.

Facing to the index 39 of the mode dial 30, a cancel/return button 44 and a menu/execute button 46 are disposed above and below the index 39, respectively. The cancel/return button 44 is used when deleting (canceling) an item selected from the menu or stepping back at a previous operation state; on the other hand, the menu/execute button 46 is used when shifting a normal screen in the respective mode to the menu screen, deciding the selected contents, executing (plus confirming) the process, or so forth.

Further, a battery cover 48 which is opened and closed is provided at the bottom of the digital camera 10. The battery cover 48 has a structure in which a battery (not shown in FIG. 3 but in FIG. 4 with a reference number 56) is inserted in a direction along the grip 21.

FIG. 4 is a block diagram showing an inner structure of the digital camera 10. CPU 50 is a control part for controlling the respective circuits based on an inputted signal from an operating part 52, and performs controls such as the followings: controlling over display of the liquid crystal monitor 28, controlling strobe emission, auto-focus (AF) calculation, and auto-exposure (AE) calculation.

The operating part 52 is a block which includes an instruction input means such as the power source switch 24, the release button 22, the mode dial 30, and the four-direction button 32. When the power source switch is turned on, the CPU 50 transmits a command to a power source control circuit 54, and supplies electricity to the respective parts of the digital camera 10 via the power source control circuit 38 from an external power source which is connected with a battery 56 or a DC power source terminal (not shown), whereby enables the respective circuits to operate. The battery may be a rechargeable battery (secondary battery) or may also be a dry cell (primary battery) on a market.

The taking lens 12 is constructed of one or plural lenses, and may be a single-focus lens or one which can change a focal length such as a zoom lens. A light passing through the taking lens 12 is adjusted its amount by an iris 58 and enters into a CCD 60. Photo sensors are arranged in a series on a plane of a light receiving surface of the CCD 60, and a subject image formed on the light receiving surface of the CCD 60 is converted into signal charge of an amount corresponding with an amount of the light which has entered through the respective photo sensors. In addition, the CCD 60 has an electronic shutter function which can control a charge accumulation time (i.e. shutter speed) of the respective photo sensors.

The signal charge which has been charged in the above-described manner is then read out in an order as a voltage signal (image signal) corresponding with the signal charge in accordance with pulses provided from a control circuit 62 of an imaging system.

The image signal outputted from the CCD 60 is sent to an analog signal processing part 64, which includes a sampling hold circuit, a color separation circuit, a gain adjustment circuit, and the like, and in which followings are performed: a coefficient double sampling (CDS), a color separation for separating into the signals of R, G, and B, and adjusting signal levels of the respective signals (pre-white balance process).

The signal outputted from the analog signal processing part 64 is converted into a digital signal by an A/D converter and is added to a digital signal processing part 68, which serves as an image processing means including circuits such as a brightness/color difference signal producing circuit, a gamma correction circuit, a sharpness correction circuit, a contrast correcting circuit, and a white balance correcting circuit, and processes an image signal in accordance with a command from the CPU 50.

Image data inputted to the digital signal processing part 68 is converted into a brightness signal (Y signal) and a color-difference signal (Cr and Cb signals) and performed the predetermined processes such as gamma correction, then is stored in a memory 70. The image data stored in the memory 70 is firstly read out in accordance with an instruction of the CPU 50, secondly converted into an analog signal through a D/A converter 72, then converted into a predetermined signal format such as an NTSC format, and finally outputted to a video output terminal 74 and the liquid crystal monitor 28.

The image data of the memory 70 is periodically updated by an image signal outputted from the CCD 60 and a video signal produced from the image data is supplied to the liquid crystal monitor 28, whereby the image which is inputted via the CCD 60 is displayed on the liquid crystal monitor 28 at a real time. A photographer can confirm an angle of view by referring to an image on the liquid crystal monitor 28 or by using an optical finder 34.

When a taking mode is set with the mode dial 30 and the release button 22 is pressed, an instruction signal for starting taking (“release ON”) is outputted. The CPU 50 detects the release ON signal, and sends a command to the control circuit 62 of the imaging system, which then controls focussing with a lens drive part 76 and at the same time controls a charge accumulation time at the iris 58 and the CCD 60 so as to control exposure.

In response to the full-press operation of the release button 22, taking of the image data to be recorded is started. If a mode for compressing and recording the image data is selected, the CPU 50 sends a command to a compression-expansion circuit 78, by which the image data on the memory 70 is compressed in accordance with a predetermined format such as JPEG.

The compressed image data is recorded in a memory card 82 through a card interface 80. If a mode for recording non-compressed image data (non-compression mode) is selected, the compression process by the compression-expansion circuit is omitted, and the image data not compressed is recorded in the memory card 82.

In the digital camera 10 of the present embodiment, a smart media (Solid-State Floppy Disk Card) is applied as a means for storing the image data. However, a form of a record media is not limited to that; a PC card, a compact flash, a magnetic disk, an optical disk, an optical magnetic disk, a memory stick, and the like may be used. In other words, variety of types of media may be used which are readable and writable electrically, magnetically, or optically, or even a combination of them, and a signal process means and an interface are adapted corresponding with a medium to be used. Moreover, plural media may be attached regardless of types of record media. Further, a means for storing an image file is not limited to a removable media which is detachable to the body of the camera, but a record medium (inner memory) which is built in the digital camera.

When a reproducing mode is set with a mode dial 30, the image file is read out from the memory card 82. The read out image data is now expanded by the expansion circuit 78 as required, and is outputted to the video output terminal 74 and the liquid crystal monitor 28 through the D/A converter 72.

The digital camera 10 has a wireless communication part 84 by which image data and the respective signals can be exchanged. An EEPROM 86 stores identification data (ID data) for specifying a communication correspondence and external equipment with which the CPU 50 determines equipment to be communicated with. The CPU 50 also encodes data to be transmitted by using the identification data of the communication correspondence and transmits the data from the wireless communication part 84.

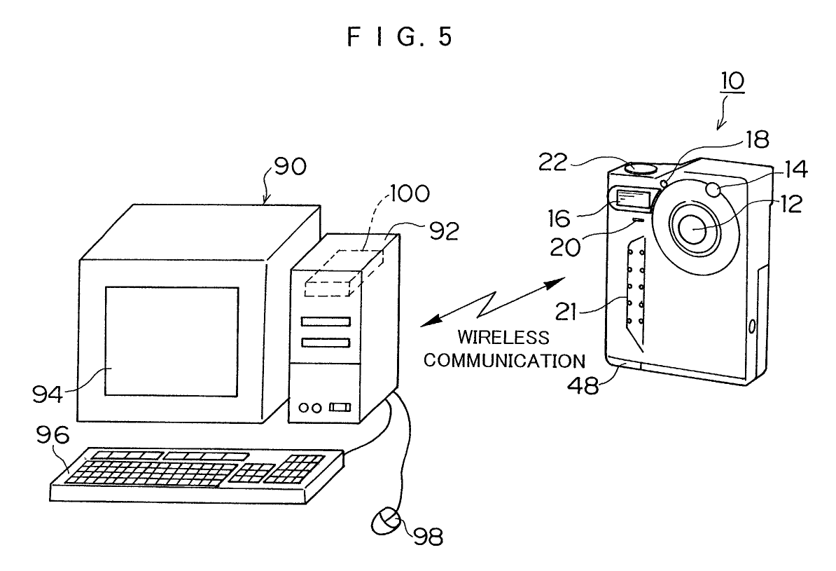

FIG. 5 is a schematic view of a system which is a combination of the digital camera 10 and a personal computer 90, which comprises a body 92, a display 94, keyboards 96, and a mouse 98, and which is provided with a wireless communication part 100 like the digital camera 10 and thus has a function to exchange the image data and the respective signals through the wireless communication part 100.

Now, an operation of the digital camera (electronic camera) 10 and the personal computer 90 which are thus constructed will be described.

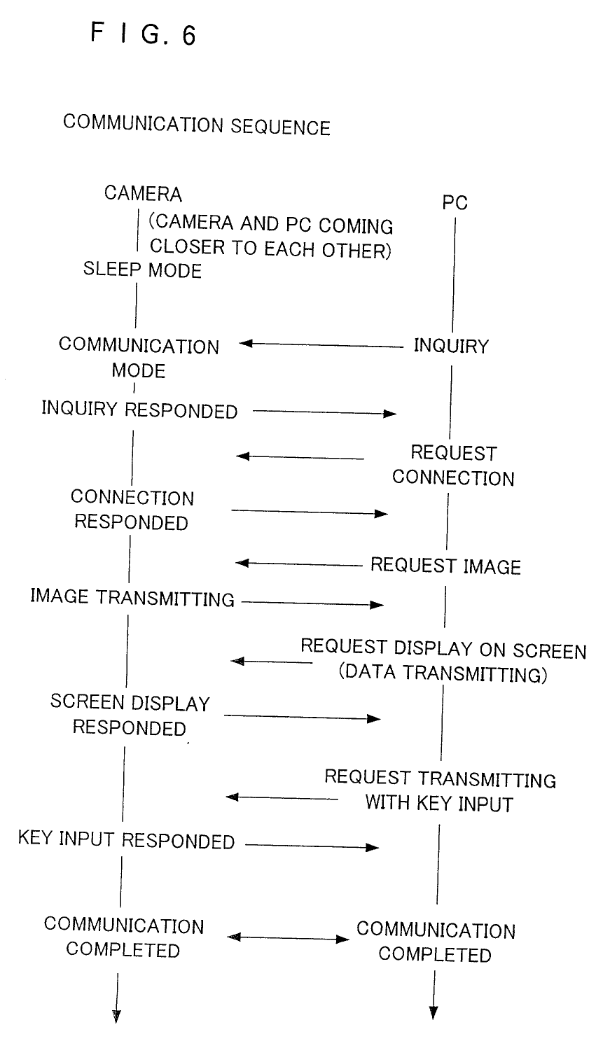

FIG. 6 is a view of a communication sequence of the digital camera 10 and the personal computer (PC) 90. After a taking operation by the digital camera 10, the body of the camera is set at an off state or a sleep state by an operating part 52. In the digital camera 10 and the PC 90, data related to a device which is a correspondence is registered beforehand. When the digital camera 10 comes close to the external apparatus (in this case the PC 90) being related beforehand, and becomes closer than the predetermined distance to communicate with each other, the PC 90 outputs an “INQUIRY” signal, and enables the digital camera 10 in an operating mode via a wireless communication.

The digital camera 10 which has received the “INQUIRY” signal from the PC 90 returns an “INQUIRY RESPONDED” to the PC 90, which then outputs “REQUEST CONNECTION”. When the digital camera 10 returns “CONNECTION RESPONDED”, the PC 90 transmits “REQUEST IMAGE”. In response to receiving of “REQUEST IMAGE”, the digital camera 10 transfers to the PC 90, via a wireless communication, a newly taken image which has not been recorded in the PC 90 among the image data recorded in the body of the digital camera 10.

The correspondence to be connected with is selected based on the identification data (ID data) which has been registered beforehand, and the contents of the transmitted data is encoded based on the identification data, whereby security is protected.

The PC 90 which received the data of the newly taken image from the digital camera 10 decodes the encoded data so that the image can be viewed. At the PC 90 side, the image transmitted from the digital camera 10 is classified in accordance with accessory data such as date and taking condition which are attached to the respective image data, and the image is displayed to the user by a folder display under an assumption that the image is stored in a virtual folder with respect to the classification keys. The virtual folder display is presented to the display 92 of the PC 90 or the liquid crystal monitor 28 of the digital camera 10, or both of them. Therefore, the user can quickly select a desired image to view.

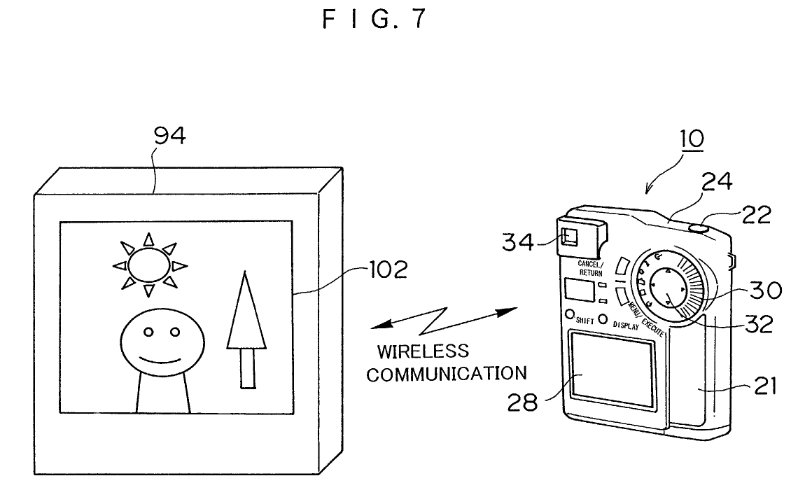

The PC 90 transmits “REQUEST SCREEN DISPLAY” and necessary data to the digital camera 10, which then returns “SCREEN DISPLAY RESPONDED”. The PC 90 which has received “SCREEN DISPLAY RESPONDED” performs image display on the display 94 in accordance with the display instruction (refer to FIG. 7). In a state where an image is being displayed, remote-controlled operations such as forwarding a page of displayed images, enlarging display, and deletion of image are then possible by using operation keys like the four-direction button 32 of the digital camera 10 and other keys. At that time, an operating guide may also be displayed on the liquid monitor 28 of the digital camera 10 for showing a relationship between operation contents and operation keys.

The PC 90 outputs “REQUEST TRANSMITTING WITH KEY INPUT”, and waits for a key input from the digital camera 10. When the user performs a predetermined operation from the operating part 52 of the digital camera 10, the digital camera 10 transmits a command corresponding with the operation, that is, “KEY INPUT RESPONDED”. The PC 90 executed a corresponding process in accordance with the received command. When the digital camera 10 or the PC 90 instructs completion of a communication, the data exchanging is completed.

FIG. 6 has shown an example where the digital camera 10 automatically enters into a communication mode when returning from a sleeping state (inactive state) so as to serve as a remote-controlled transmitting device; however, a mode may be switched by a predetermined operation by the operator.

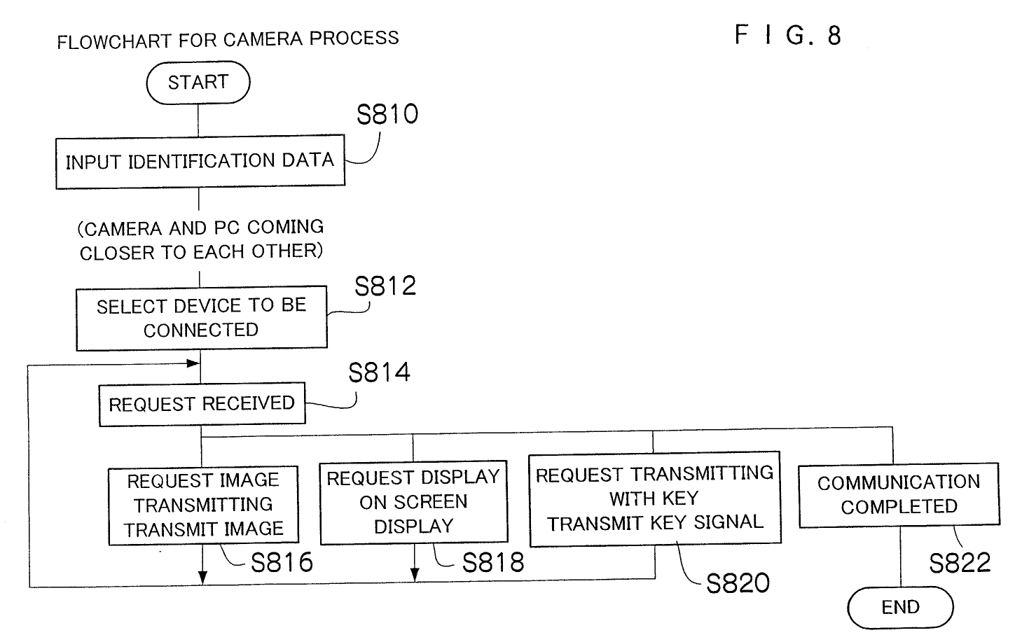

FIG. 7 shows a state where a viewed image 102 is displayed on the display 94. FIG. 8 is a flowchart showing a process of the digital camera 10. As seen from the flowchart, identification data of the external equipment to be communicated with (the PC 90 in this example) is inputted (Step S810). As the digital camera 10 and the PC 90 come to each other within a predetermined range of distance, they automatically set up a communication so as to exchange data and perform a process for selecting a device to be connected with (Step S812).

Then, the PC 90 receives a request signal (Step S814), and a process corresponding with contents of the received request is performed (Steps S816 through S822). If the PC 90 receives “REQUEST IMAGE TRANSMITTING”, it performs a process for image transmitting (Step S816). If the PC 90 receives “REQUEST DISPLAY ON SCREEN”, it performs a process for designating an image to be displayed on the screen (Step S818). If the PC 90 receives “REQUEST TRANSMITTING WITH KEY INPUT”, it transmits a key signal accompanied by an operation with a key (Step S820). After Steps S816, S818, or S820, the process returns to Step S814.

When a command “COMMUNICATION COMPLETED” is received at Step S814, the above-described communication process is completed (Step S822).

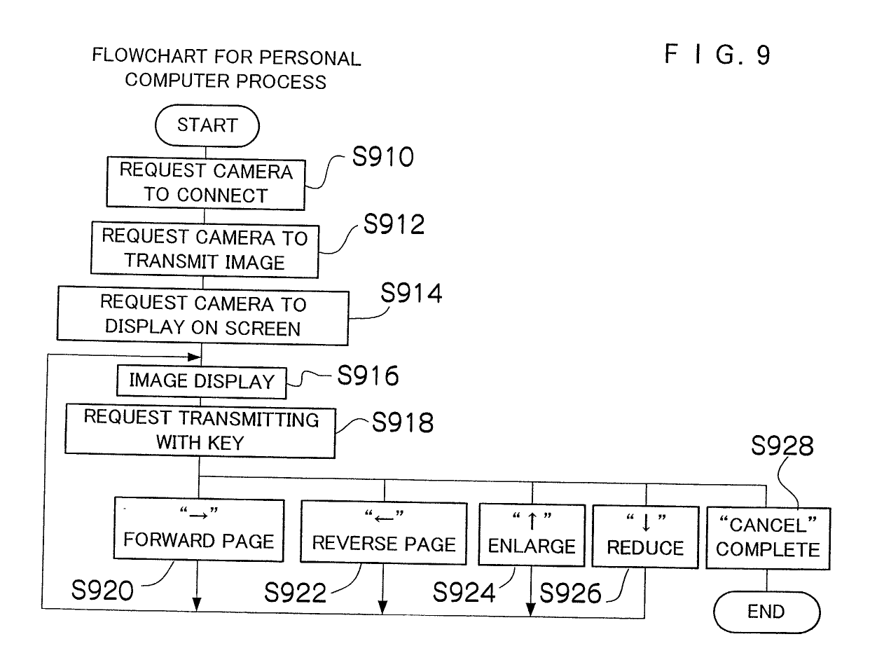

FIG. 9 is a flowchart showing a process of the personal computer (PC) 90. As seen from FIG. 9, the PC 90 request a connection to the digital camera 10 (Step S910), and requests image transmitting to the digital camera 10 (Step S912) after receiving a response. When receiving the image data, the PC 90 then requests displaying the image on the screen (Step S914). When the digital camera 10 designates an image to be displayed through a remote-controlled operation, the image related to the designation is displayed on the display 94 (Step S916).

After that, the PC requests transmitting with a key input (Step S918), and waits for an input of an instruction from the digital camera 10, then a process corresponding with contents of the received key signal is performed (Steps S920 through S928). In this process, operations corresponding with the key signal is defined by the PC 90. When receiving a key signal corresponding with pressing of the right key of the four-direction button 32, the PC performs a process for forwarding pages (Step S920), whereby an image of the next frame is displayed on the display 94.

When receiving a key signal corresponding with pressing of the left key of the four-direction button 32, the PC 90 performs a process for reversing a page (Step S922), whereby an image of a previous frame is displayed on the display 94.

When receiving a key signal corresponding with pressing of the up key of the four-direction button 32, the PC 90 performs a process for enlarging a current image by a reproduction zoom function (Step S924). Moreover, When receiving a key signal corresponding with pressing of the down key of the four-direction button 32, the PC performs a process for reducing an image (“zoom-down process”) which is enlarged and displayed (Step S926). After Steps S920, S922, S924, or S926, the process returns to Step S916, and the displayed contents are changed. When receiving a key signal corresponding with pressing of the cancel/return button 44 (“CANCEL”) at Step S928, the communication is completed (Step S928).

In the above-described embodiment, examples are presented where a viewed image on the display 92 is switched or enlarged/reduced through operations by the digital camera 10. However, operations are not limited to that; image editing operations such as trimming, rotating, correcting, and filter process may also be performed.

In the above-described embodiment, the personal computer 90 is applied as external equipment; however, a range of application of the present invention is not limited to that. The present invention can also be applied to a variety of devices which process image data such as a device for storing images (storage means), image searching device, image reproducing device, image managing device and image processing (modifying) device.

In the above-described embodiment, a camera which records a still image is exemplified; however, the present invention can also be applied to a digital camera and a video camera with a function to record a moving image.

As described hereinabove, according to the present invention, a remote-controlled operation of an external apparatus is possible by using a wireless communication means for transmitting image data in order to transmit operation data of the operating part of the body of the camera. Therefore, the electronic camera of the present invention can seamlessly (=smoothly) perform a connective operations with the external equipment, and the user can perform a variety of processes such as taking, deleting, and storing of an image, by operating the electronic camera by hand without touching the external apparatus.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An electronic camera, comprising:
a body;
a control part provided to the body;
a wireless communication device which transmits image data,
wherein the wireless communication device transmits operation information corresponding with operation of the control part to an external apparatus to remotely control the external apparatus.

2. An external apparatus which is remotely controlled by the electronic camera as defined in claim 1, the external apparatus comprising:
a wireless communication device which communicates with the wireless communication device of the electronic camera; and
a displaying device which classifies images received from the electronic camera into image groups according to accessory information attached to the images and displays virtual folders, each of the virtual folders comprising each of the image groups.

3. The electronic camera as set forth in claim 1, further comprising:
a storing device that stores identification information for specifying the external apparatus;
a specifying device that specifies the external apparatus from the identification information stored in the storing device; and
an encoding device that encodes the image data and the operation information according to the identification information.

4. An external apparatus which is remotely controlled by the electronic camera as defined in claim 3, the external apparatus comprising:
a wireless communication device which communicates with the wireless communication device of the electronic camera; and
a displaying device which classifies images received from the electronic camera into image groups according to accessory information attached to the images and displays virtual folders, each of the virtual folders comprising each of the image groups.

5. An electronic camera, comprising:
a body;
a taking lens;
an imaging device which converts a light which has entered the electronic camera through the taking lens into electric signals;
a recording device which records an image captured by the imaging device in a storage medium;
a wireless communication device which transmits image data;
a control part provided to the body, operational directions over an external device being entered through the control part; and
an operation information outputting device which transmits, through the wireless communication device, operation information corresponding with operation of the control part to the external apparatus to remotely control the external apparatus.

6. An external apparatus which is remotely controlled by the electronic camera as defined in claim 5, the external apparatus comprising:
a wireless communication device which communicates with the wireless communication device of the electronic camera; and
a displaying device which classifies images received from the electronic camera into image groups according to accessory information attached to the images and displays virtual folders, each of the virtual folders comprising each of the image groups.

7. The electronic camera as set forth in claim 5, further comprising:
a storing device that stores identification information for specifying the external apparatus;
a specifying device that specifies the external apparatus from the identification information stored in the storing device; and
an encoding device that encodes the image data and the operation information according to the identification information.

8. An external apparatus which is remotely controlled by the electronic camera as defined in claim 7, the external apparatus comprising:
a wireless communication device which communicates with the wireless communication device of the electronic camera; and
a displaying device which classifies images received from the electronic camera into image groups according to accessory information attached to the images and displays virtual folders, each of the virtual folders comprising each of the image groups.

9. A remote-control operation system for an external apparatus, the system comprising an electronic camera and the external apparatus, wherein:
an electronic camera comprises:
a body;
a taking lens;
an imaging device which converts a light which has entered the electronic camera through the taking lens into electric signals;
a recording device which records an image captured by the imaging device in a storage medium;
a first wireless communication device which transmits image data;
a control part provided to the body, operational directions over the external device being entered through the control part; and
an operation information outputting device which transmits operation information corresponding with operation of the control part to the external apparatus to remotely control the external apparatus, and
the external device comprises:
a second wireless communication device which communicates with the first wireless communication device; and
a displaying device which classifies images received from the electronic camera into image groups according to accessory information attached to the images and displays virtual folders, each of the virtual folders comprising each of the image groups,
wherein the external apparatus operates according to the operation information received from the electronic camera.
